(19) United States
(12) Patent Application Publication
(10) Pub. No.: US 2014/0085908 A1
(43) Pub. Date: Mar. 27, 2014

(54) LED LAMP STRUCTURE HAVING FREE CONVECTION COOLING

(71) Applicant: Ming-Yuan WU, Taipei (TW)

(72) Inventor: Ming-Yuan WU, Taipei (TW)

(21) Appl. No.: 13/783,961

(22) Filed: Mar. 4, 2013

(30) Foreign Application Priority Data
Sep. 25, 2012 (TW) 101135122

(51) Int. Cl. F21V 29/00

(52) U.S. Cl. CPC F21V 29/004; F21V 29/20
USPC 362/373; 362/382

(57) ABSTRACT

A LED lamp structure includes a light emitting module and a lamp holder. The lamp holder has a plurality of air guiding slots and the through holes. During operation of the LED lamp, the free convection of ambient air is allowed from the air guiding slot to the through hole to dissipate the generated heat and decrease the working temperature of the LED lamp. The structure is simple and easy to manufacture. Furthermore, the easy-to-process material is utilized to make the mass production be easy. Also, the cost has certainly decreased.

### BACKGROUND OF THE INVENTION

1. Field of Invention

The present invention relates to a LED lamp, in particular to a LED lamp structure having free convection cooling with good thermal dissipation characteristic.

2. Related Art

As a solid state light source, LEDs (light-emitting diodes) are a product with long life span, firm structure, low power consumption and flexible dimension such that they are becoming to take the place of conventional high pressure halide lamps in a wide range of lighting applications. However, LEDs would generate comparatively high heat energy, with a result of their high light fades and shortened life span. This leads to limited applications of LEDs to some extent.

A currently available LED lamp, which is used for the purpose of illumination, usually comprises a plurality of LED light sources to form a LED array in order to reach the required illuminance and power, because a single one LED light source has relatively low illuminance and power. The LED array structure may satisfy the requirement for illuminance, but it causes several problems including heat concentration, and high temperature at local positions. Because of the absence of specialized means for heat conduction and heat dissipation, the heat energy generated by the plurality of LED light sources cannot be effectively dissipated, such that the temperature of the housing of the lamp is so high to the extent that people would get scalded and that this lamp is vulnerable to get burned out.

Presently, great efforts have been made to provide various solutions in an attempt to tackle the heat dissipation of the LED lighting fixtures. However, these solutions are either less effective to dissipate the heat, or are expensive and structurally complicated though being effective on heat dissipation. Therefore, there is a need for improving the currently available LED lamps used for the purpose of illumination in terms of their thermal dissipation with low costs.

### SUMMARY OF THE INVENTION

The present invention overcomes the above-described and other problems and disadvantages in the prior art by providing a LED lamp to dissipate the heat generated by the LED and to mass-produce easily with cost down.

An object of the present invention is to address the drawbacks in the prior art mentioned above by providing a LED lamp which has good characteristics of thermal dissipation by a free convection of ambient air. The LED lamp can also have a prolonged service life and decreased light fade.

It is another objective of the present invention to provide the LED lamp with simplified structure. The plastic materials may be used for the lamp holder to reduce the material costs.

Accordingly, the present invention provides a LED lamp including a lamp holder, a light emitting module and a radiator. A free convection of ambient air is allowed from an air guiding slot to a through hole of the light holder to dissipate a heat generated by the light emitting module. Therefore, the LED lamp can also have a prolonged service life and decreased light fade.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIG. 1 is a perspective view of a lamp structure of a first preferred embodiment of the present invention;

FIG. 2 is an exploded perspective view of the LED lamp of FIG. 1;

FIG. 3 is a partial cross-sectional view of the LED lamp of FIG. 1;

FIG. 4 is a schematic view of a lamp cover of the LED lamp of another preferred embodiment of FIG. 1;

FIG. 5 is a perspective view of a lamp structure of a second preferred embodiment of the present invention;

FIG. 6 is a schematic view of a lamp cover of the LED lamp of another preferred embodiment of FIG. 5;

FIG. 7 is a perspective view of a lamp structure of a third preferred embodiment of the present invention;

FIG. 8 is a schematic view of a lamp cover of the LED lamp of another preferred embodiment of FIG. 7;

FIG. 9 is a perspective view of a lamp structure of a forth preferred embodiment of the present invention; and

FIG. 10 is a schematic view of a lamp cover of the LED lamp of another preferred embodiment of FIG. 9.

### DETAILED DESCRIPTION OF THE INVENTION

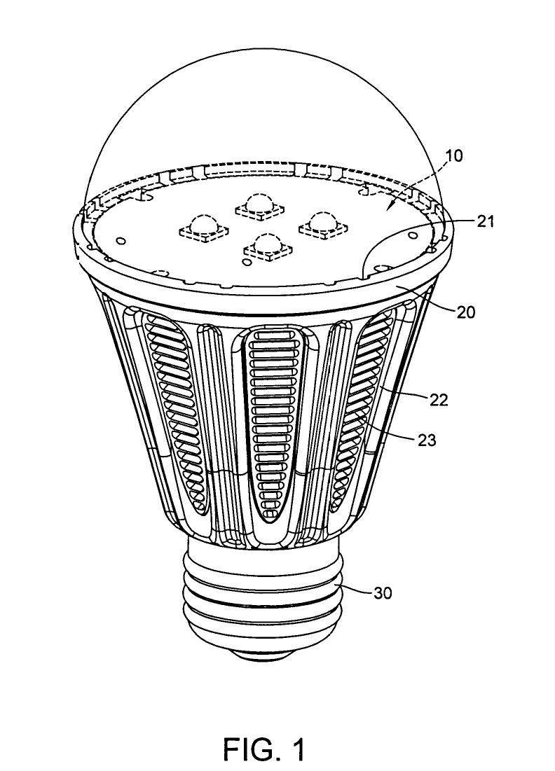

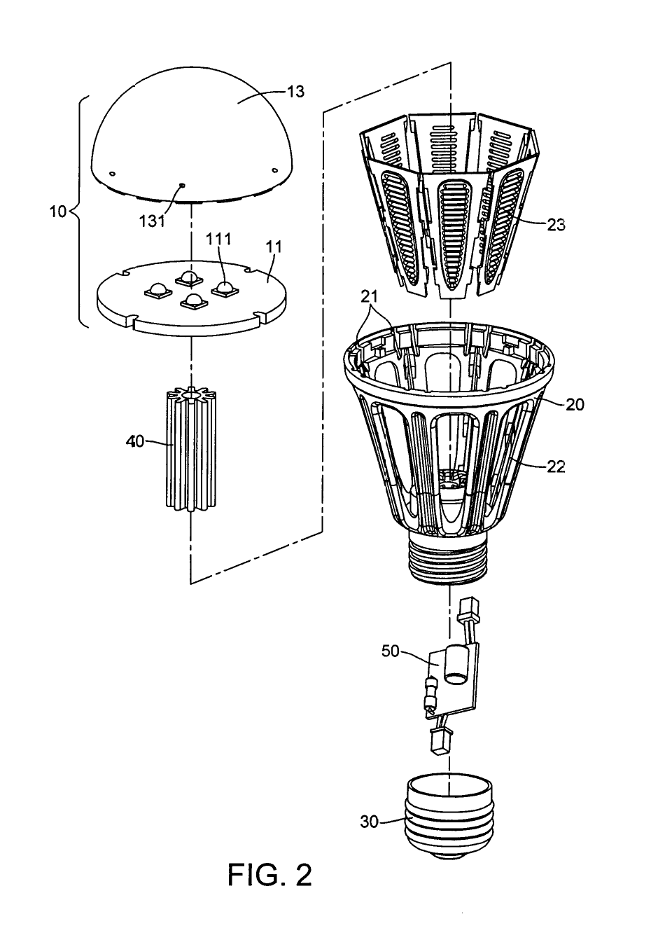

A LED lamp structure of a first embodiment of the present invention is shown in FIGS. 1-2. The LED lamp structure includes a light emitting module 10, a lamp holder 20 and a radiator 23. As shown in FIG. 1, the LED lamp is a bulb-type fluorescent lamp. A lamp base 30 may be detachable and changeable with different type of bases. The light emitting module 10 is disposed on the top of the lamp holder 20 by buckle, hook, clip or other tightening or fastening mechanism. At least one air guiding slot 21 is formed on the top of the lamp holder 20 and at least one through hole 22 is formed on a sidewall of the lamp holder 20. Therefore, a free convection of ambient air is allowed from the air guiding slot 21 to the through hole 22 to dissipate a heat generated by the light emitting module 10.

The light emitting module 10 includes a substrate 11 and a lamp cover 13. A plurality of LEDs 111 are disposed on the substrate 11 and configured to emit lights. The LEDs 111 may be a surface mounting device (SMD) or have a chip on board (COB) package structure. The substrate 11 has at least one notch at the periphery to assemble with the lamp holder 20. The lamp cover 13 is disposed on the top of the lamp holder 20 and covers the substrate 11 to protect the LEDs 111. The lamp cover 13 can be made of glass, a polymer, or any other transparent or translucent material permitting light from the LEDs 111 to reach surrounding areas. The lamp cover 13 may also include decorative patterns, ribs reinforcing the strength thereof, prism shapes to diffuse light, color filters to control emitted light, or other properties or structures known for light covers in the art. The lamp cover 13 includes at least one inlet hole 131 to enhance the free convection.

The lamp holder 20 includes the air guiding slot 21, the through hole 22 and the lamp base 30. A driver module 50 is connected to the lamp base 30 and the light emitting module 10 and is disposed in the lamp base 30. The driver module 50 is adapted to control or regulate the total current for the LEDs 111. Also the driver module 50 may be integrated in the substrate 11 of the light emitting module 10 to receive the AC power directly.

The radiator 23 includes a plurality of radiating plates, which are connected to each other to form a sleeve type. A radiating column 40 is connected to the light emitting module 10 and mounted on the lamp holder 20. The radiating column 40 and the radiator 23 are made of materials having high thermal conductivity, such as aluminum and its alloy. The radiating column 40 is utilized to support the light emitting module 10 and dissipate the generated heat. The radiator 23 is disposed to adjacent to the through hole 22 of the lamp holder 20.

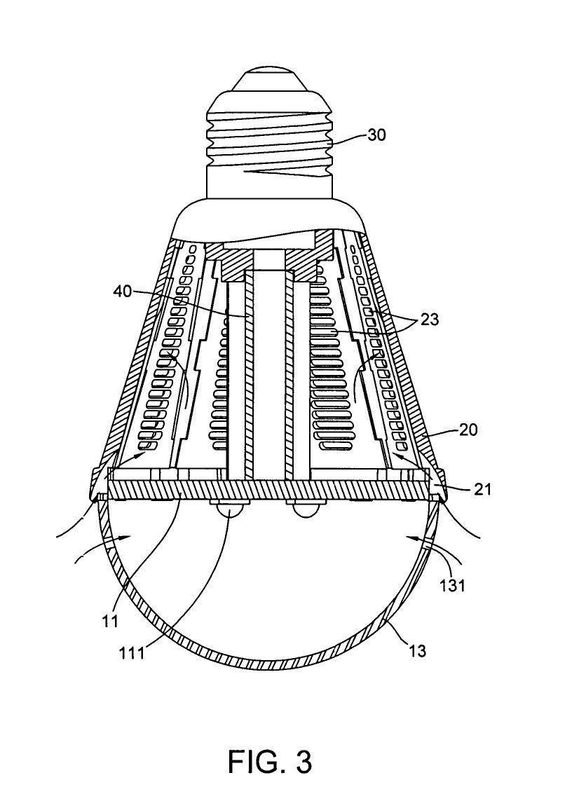

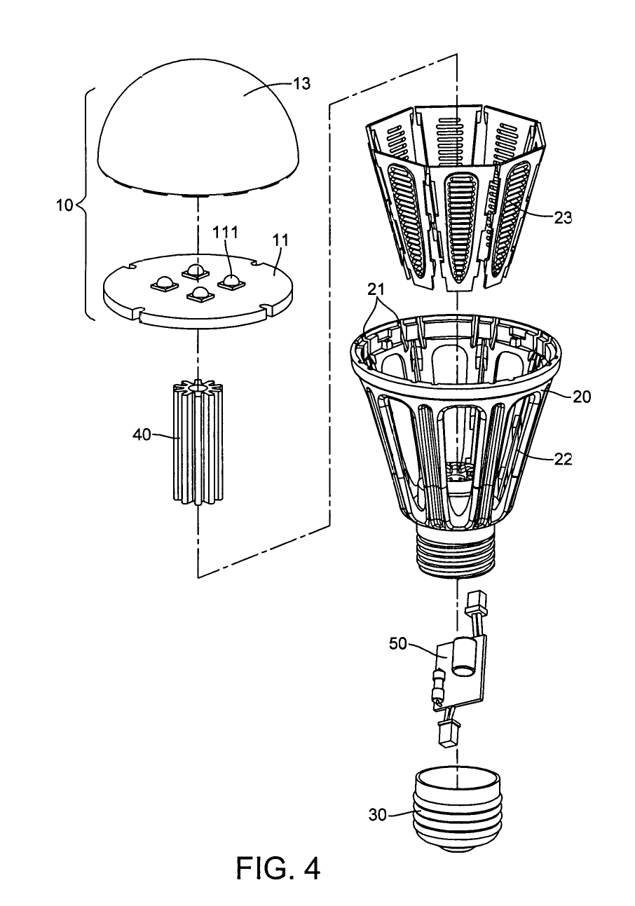

As refer to FIG. 3, when the LED lamp is in operation, the heat generated by the LEDs 111 make the temperature of the air high inside the lamp holder 20 through the radiating column 40. The hot air is escaped outside through the radiator 23 and the through hole 22. Therefore, the free convection of ambient air is allowed from the air guiding slot 21 to the through hole 22 to dissipate a heat generated by the light emitting module 10. Also, the ambient air may also flow to the LEDs 111 from the inlet hole 131 to enhance the free convection. However, the lamp cover 13 may be without the inlet hole 131, please refer to FIG. 4.

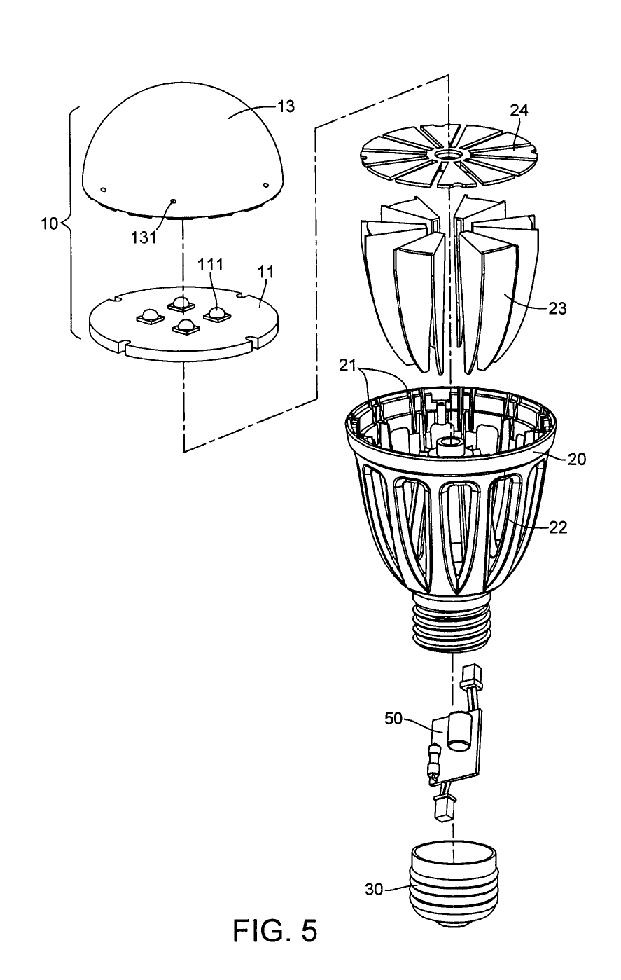

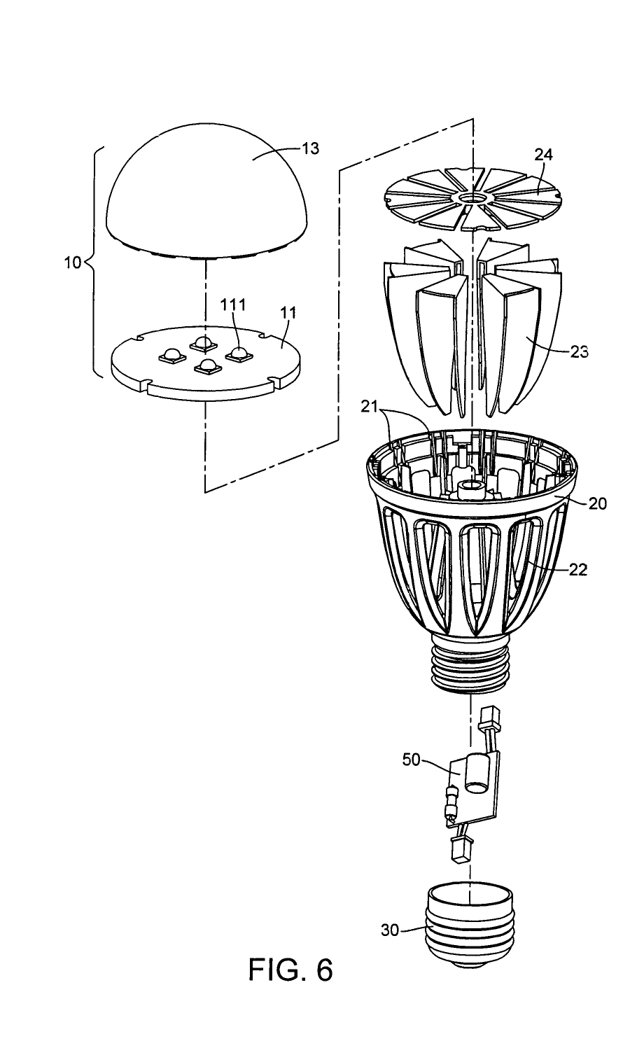

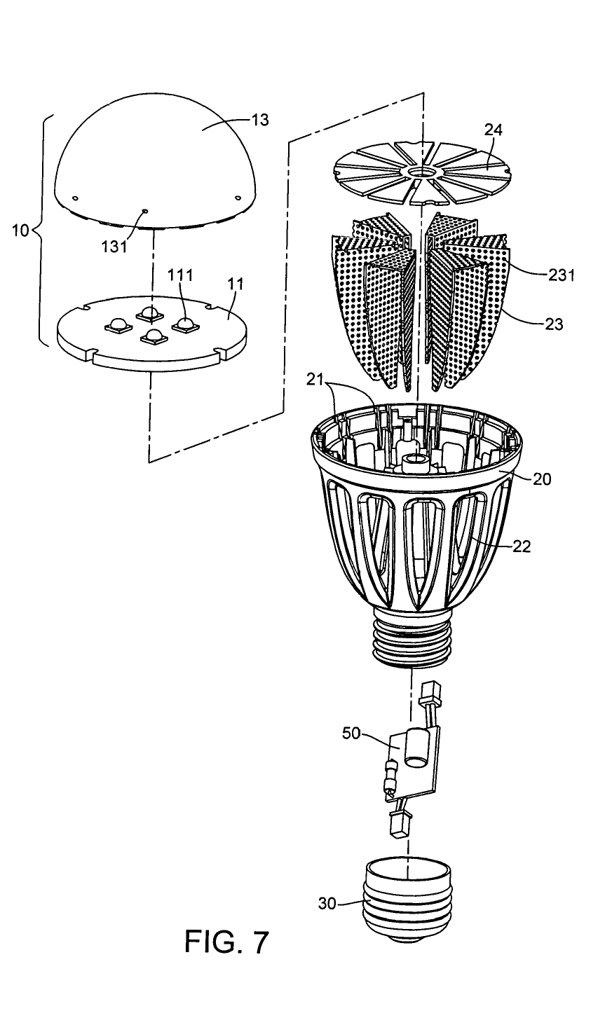

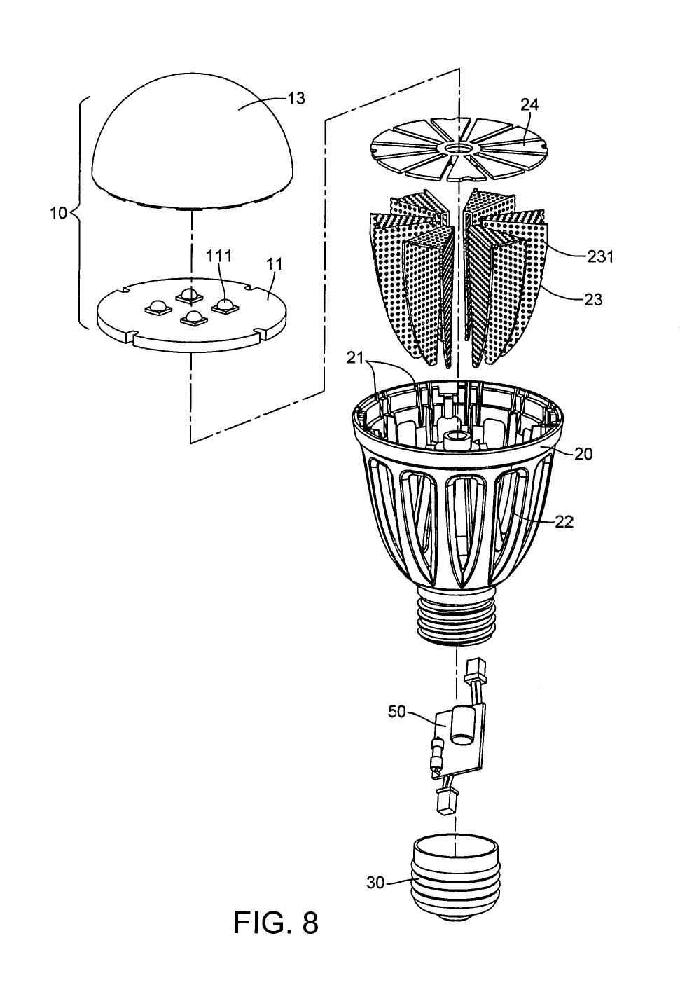

Please refer to FIG. 5, the radiator 23 may include a plurality of individual U-shaped radiating plates. A fixture 24 is utilized to fix the U-shaped radiating plates. Also, the contacted area with the substrate 11 is also increased to improve the heat dissipation. The lamp cover 13 may be with or without the inlet hole 131, please refer to FIG. 6. A free convection of ambient air is allowed from the air guiding slot 21 to the through hole 22 to dissipate a heat generated by the light emitting module 10. Furthermore, the radiator 23 (U-shaped radiating plate) may have a plurality of convection holes 231 thereon to increase the heat dissipation, please see FIG. 7. The lamp cover 13 may be with or without the inlet hole 131, please refer to FIG. 8.

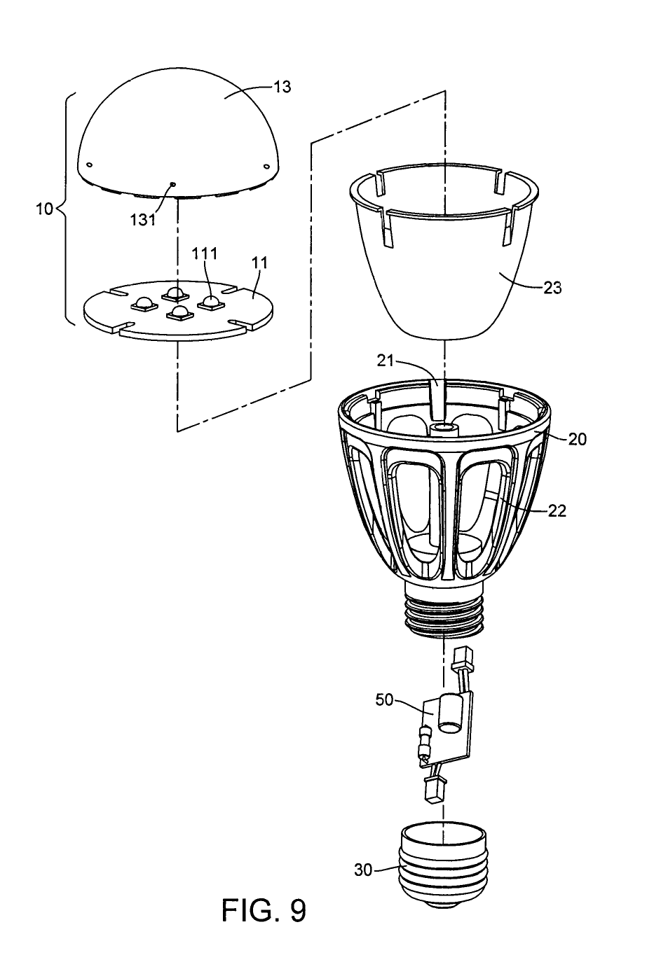

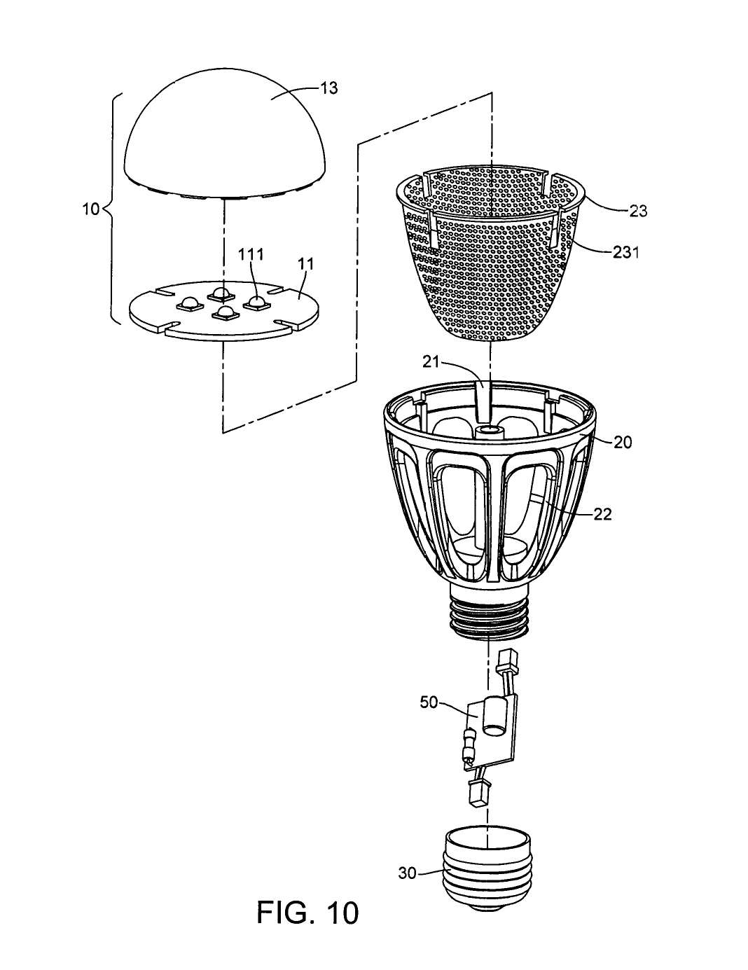

Please refer to FIG. 9, the radiator 23 is a cup-shaped radiating element and the lamp cover 13 may has the inlet hole 131. Please refer to FIG. 10, the radiator 23 (cup-shaped radiating element) may have a plurality of convection holes 231 thereon to increase the heat dissipation, and the lamp cover 13 may be without the inlet hole 131.

Accordingly, the present invention provides a LED lamp which has good characteristics of thermal dissipation by a free convection of ambient air. The LED lamp can also have a prolonged service life and decreased light fade. Also, the LED lamp has simplified structure. The plastic materials may be used for the lamp holder to reduce the material costs.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A LED lamp structure, comprising:
a lamp holder, including:
at least one air guiding slot, formed on a top of the lamp holder;
at least one through hole, formed on a sidewall of the lamp holder; and
a lamp base, mounted on a bottom end of the lamp holder;
a light emitting module, disposed on the top of the lamp holder and connected to the lamp base; and
a radiator, disposed in the lamp holder;
wherein a free convection of ambient air is allowed from the air guiding slot to the through hole to dissipate a heat generated by the light emitting module.

2. The LED lamp structure of claim 1, wherein the light emitting module comprising:
a substrate, a plurality of LEDs disposed thereon; and
a lamp cover, disposed on the top of the lamp holder and covering the substrate.

3. The LED lamp structure of claim 2, further comprising a driver module connected to the lamp base and the light emitting module.

4. The LED lamp structure of claim 3, wherein driver module is disposed in the lamp base.

5. The LED lamp structure of claim 2, wherein the lamp cover includes at least one inlet hole to enhance the free convection.

6. The LED lamp structure of claim 1, wherein the radiator includes a plurality of radiating plates.

7. The LED lamp structure of claim 6, wherein the radiating plate has a plurality of convection holes thereon.

8. The LED lamp structure of claim 6, wherein the radiator further includes a radiating column connected to the light emitting module.

9. The LED lamp structure of claim 1, wherein the radiator is a cup-shaped radiating element.

10. The LED lamp structure of claim 9, wherein the cup-shaped radiating element has a plurality of convection holes thereon.
